(19) United States
(12) Patent Application Publication
(10) Pub. No.: US 2026/0146649 A1
(43) Pub. Date: May 28, 2026

(54) BEARING CAGE WITH POCKETS HAVING RADIAL STORAGE HOLES

(71) Applicant: AKTIEBOLAGET SKF, GOTEBORG (SE)

(72) Inventor: Bryan D. ALLISON, Clymer, NY (US)

(21) Appl. No.: 18/960,018

(22) Filed: Nov. 26, 2024

(51) Int. Cl. F16C 33/38

(52) U.S. Cl. CPC F16C 33/3887

(57) ABSTRACT

A cage is for a bearing including an inner body having an inner raceway surface, an outer body disposed about the inner body so as to define an annular space, the outer body having an outer raceway surface, and a plurality of rolling elements disposed within the annular space and rollable simultaneously upon the inner raceway surface and the outer raceway surface. The cage includes an annular body disposeable within the annular space between the inner body and the outer body, having a centerline and including a plurality of pockets spaced circumferentially about the centerline. Each pocket is defined by a separate radial surface and is configured to retain a separate one of the plurality of rolling elements. At least one radial hole intersects the radial surface of one of the plurality of pockets and provides a storage space for lubricant.

### BACKGROUND OF THE INVENTION

The present invention relates to bearings, and more particularly to rolling element bearings having cages.

Rolling element bearings are well known and include an inner body having an inner raceway surface, an outer body having an outer raceway surface and a plurality of rolling elements disposed between and radially coupling the inner and outer bodies so as to rotatably couple an inner member, such as a shaft, etc., with an outer member, such as a housing, a wheel hub, etc. Certain rolling element bearings include a cage for maintaining a desired circumferential spacing between the rolling elements, which may be balls, cylinders, spheroids, etc. Specifically, the cage includes a plurality of circumferentially spaced pockets, which may be entirely enclosed or have an open axial side, and each rolling element is disposed within a separate one of the pockets.

Typically, a lubricant such as oil or grease is provided within the space between the inner and outer bodies of the bearing in order to reduce friction between the points of contact between the rolling elements and the raceway surfaces, as well as between the rolling elements and the surfaces of the cage pockets. However, in certain applications such as semiconductor manufacturing, the type of lubricant is generally restricted to specific types of grease which can withstand vacuum environments. Also, the amount of such grease is limited in order to avoid grease passing out of the bearing and causing contamination. Normally, a bearing typically has 30% to 40% of the free volume between the inner and outer bodies filled with grease, but in these applications, the amount of grease is limited to about 10% of the free volume.

As a result, when the limited amount of grease breaks down, the grease loses the ability to adequately lubricate the contact points until friction torque becomes excessive and/or the locating accuracy of the bearing is reduced to below acceptable levels. At either point, the bearing is typically replaced.

### SUMMARY OF THE INVENTION

In an aspect, the present invention is cage for a bearing, the bearing including an inner body having an inner raceway surface, an outer body disposed about the inner body so as to define an annular space, the outer body having an outer raceway surface, and a plurality of rolling elements disposed within the annular space and rollable simultaneously upon the inner raceway surface and the outer raceway surface. The cage comprises an annular body disposeable within the annular space between the inner body and the outer body, having a central axis and including a plurality of pockets spaced circumferentially about the central axis. Each pocket is defined by a separate radial surface and is configured to retain a separate one of the plurality of rolling elements. Further, at least one radial hole intersects the radial surface of one of the plurality of pockets and provides a storage space for lubricant, preferably grease.

Preferably, the at least one radial hole includes a plurality of radial holes, at least one radial hole intersecting each one of the plurality of pockets, and most preferably a plurality of radial holes intersect each one of the plurality of pockets. The annular body of the cage has an inner circumferential surface and an outer circumferential surface, and the radial surface of each one of the plurality of pockets and the at least one radial hole extends radially between the inner and outer circumferential surfaces of the annular body. Further, each one of the radial holes is preferably defined by a cylindrical surface extending radially between the inner and outer circumferential surfaces of the annular body and intersecting the radial surface of one pocket so as to define a rectangular opening between the pocket and the radial hole.

Further, each one of the plurality of pockets has a center and the at least one radial hole preferably includes a plurality of sets of radial holes, each one of the sets of radial holes being spaced circumferentially about the center of a separate one of the plurality of pockets. As such, the radial surface of each one of the pockets is collectively defined by a plurality of radial surface sections spaced circumferentially about the center of the pocket, a separate one of a plurality of rectangular openings being located between each pair of adjacent cylindrical surface sections. Further, each radial hole preferably has a first opening at the inner circumferential surface of the annular body and a second opening at the outer circumferential surface of the annular body.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a broken-away, axial cross-sectional view of a bearing with a cage having pockets with radial holes in accordance with the present invention, shown mounted between a shaft and a housing;

FIG. 2 is a perspective view of the present cage;

FIG. 3 is a broken-away, enlarged front plan view of one pocket of the present cage, shown with a plurality of rectangular radial holes;

FIG. 4 is a broken-away, enlarged perspective view of the pocket of FIG. 3;

FIG. 5 is a broken-away, enlarged front plan view of one pocket of the present cage, shown with a plurality of circular holes;

FIG. 6 is a broken-away, enlarged front plan view of one pocket of the present cage, shown with four relatively larger circular holes;

FIG. 7 is another view of the pocket of FIG. 3, shown with an installed ball; and

FIG. 8 is a greatly enlarged view of a portion of FIG. 7, shown with lubricant within one radial hole.

### DETAILED DESCRIPTION OF THE INVENTION

Certain terminology is used in the following description for convenience only and is not limiting. The words “inner”, “inwardly” and “outer”, “outwardly” refer to directions toward and away from, respectively, a designated centerline or a geometric center of an element being described, the particular meaning being readily apparent from the context of the description.

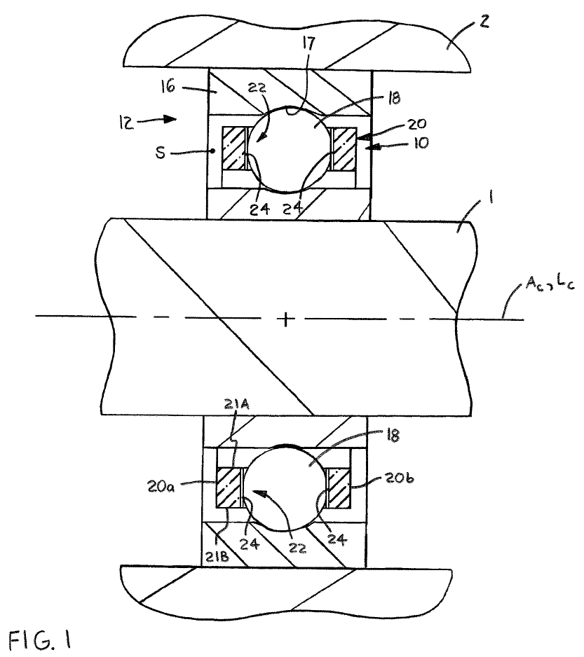

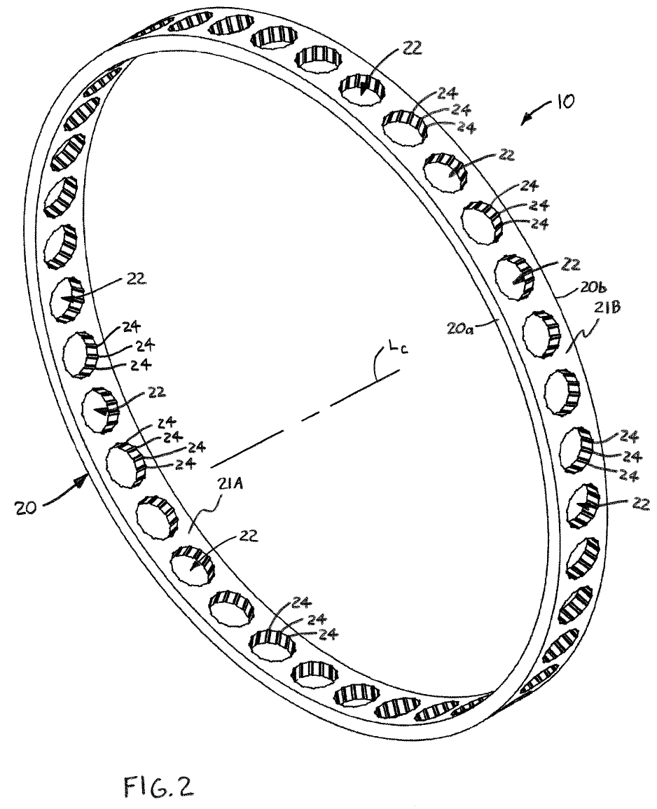

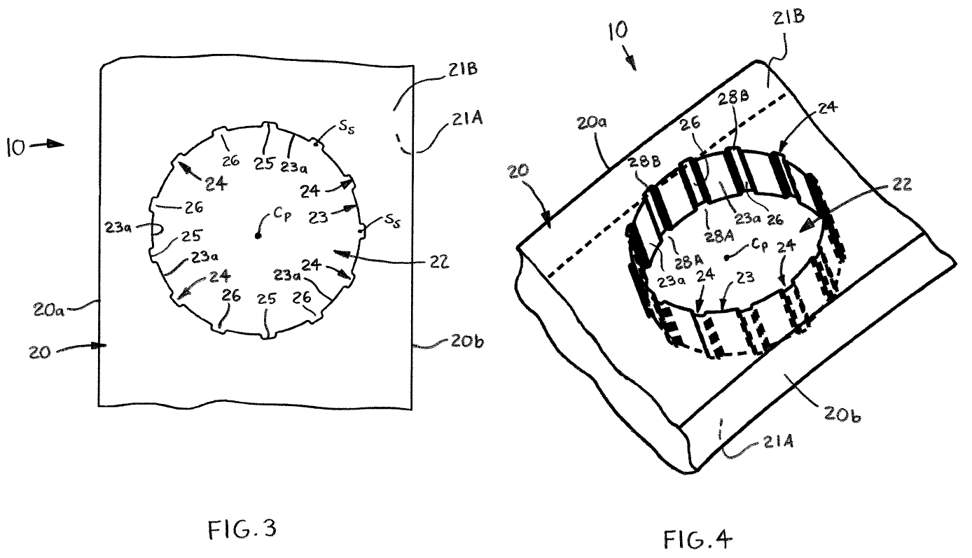

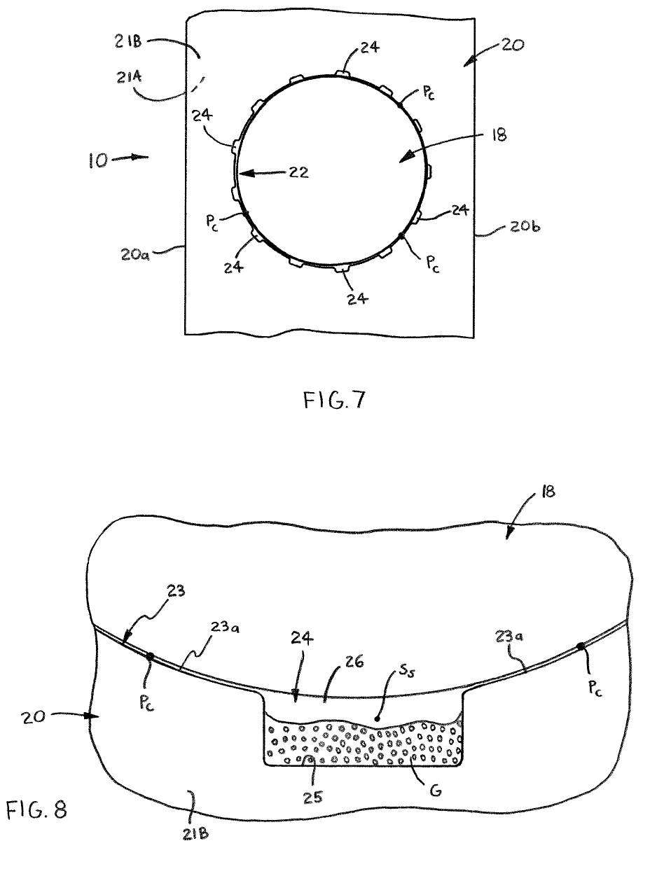

Referring now to the drawings in detail, wherein like numbers are used to indicate like elements throughout, there is shown in FIGS. 1-8 a cage 10 for a bearing 12 that is preferably used in a vacuum or other specialty environment, in particular for microchip manufacturing. The bearing 12 includes an inner body 14, which has an inner raceway surface 15 and a central axis A_{C}, and an outer body 16 disposed about the inner body 12 so as to define an annular interior space S, the outer body 16 having an outer raceway surface 17, at least one of the inner and outer bodies 14, 16 being rotatable about the central axis A_{C}. Preferably, the inner and outer bodies 14, 16 are each formed as a ring, but one or both may be formed in any other appropriate manner, such as a hub, a sleeve, a housing, etc., the inner body/ring 14 being installed about an inner member 1, such as a shaft, and the outer body/ring 16 being installed within an outer member 2, such as a housing. Further, a plurality of rolling elements 18 are disposed within the annular space S and are each rollable simultaneously upon the inner raceway surface 15 and the outer raceway surface 17. The rolling elements 18 are preferably balls, but may be cylindrical rollers, tapered rollers, spherical rollers, needles, or any other type of rolling element.

The cage 10 comprises an annular body 20 disposeable within the annular space S between the inner body 14 and the outer body 16, the body 20 having a centerline L_{C}, an inner circumferential surface 21A, an opposing outer circumferential surface 21B and first and second opposing axial ends 20a, 20b, respectively. The body 20 includes a plurality of pockets 22 spaced circumferentially about the centerline L_{C}, each pocket 22 being configured to retain a separate one of the plurality of rolling elements 18. Each one of the plurality of pockets 22 has a center C_{P} and is defined by a radial surface 23 extending at least partially around the center C_{P}, and radially between the cage inner and outer circumferential surfaces 21A, 21B. The radial surface 23 of each pocket 22 is preferably circular cylindrical for retaining a ball rolling element 18, but may be generally rectangular or have any other appropriate shape depending on the type of rolling element 18 to be retained by the cage 20.

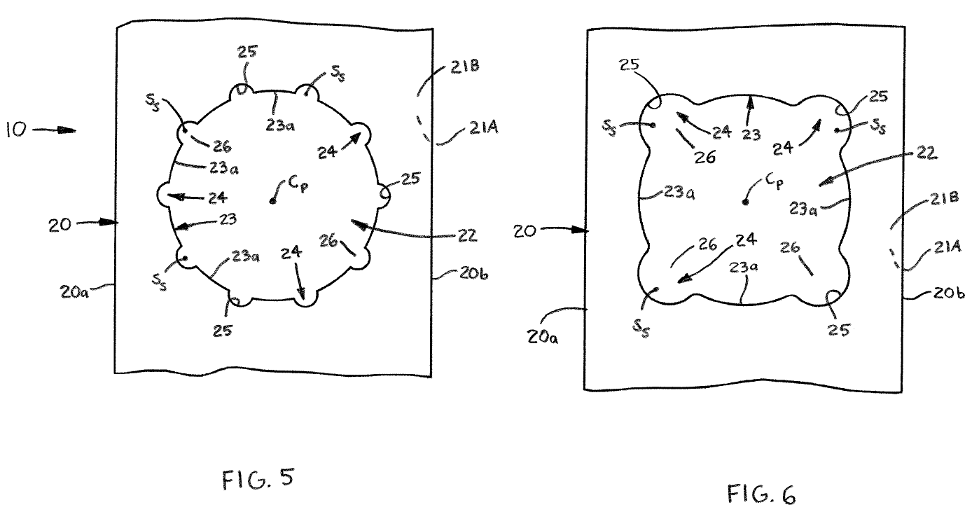

Further, the cage 10 includes at least one radial “storage” hole 24 intersecting the radial surface 23 of one of the plurality of pockets 22, and preferably includes a plurality of radial holes 24, at least one radial hole 24 intersecting each one of the plurality of pockets 22. Each radial storage hole 24 extends radially between the inner and outer circumferential surfaces 21A, 21B of the cage body 20 and provides a storage space S_{S} for lubricant, preferably grease, as best shown in FIG. 8. More specifically, each radial hole 24 is defined by a cylindrical surface 25 extending radially between the cage inner and outer circumferential surfaces 21A, 21B. Each cylindrical surface 25 is formed as an open-sided rectangle or generally “rectangular” and intersects the radial surface 23 of the connected pocket 22 so as to define a rectangular opening 26 between the pocket 22 and the radial hole 24, as best shown in FIG. 4. As such, lubricant/grease disposed within each radial hole 24 is able to pass from the storage space S_{S} through the rectangular opening 26 and lubricate points of contact P_{C} between the connected pocket 22 and the rolling element 18 retained therein, as depicted in FIG. 8. Alternatively, the cylindrical surface 25 of each radial hole 24 may be formed circular cylindrical or generally circular, as shown in FIGS. 5 and 6, triangular, star-shaped, or any other desired shape (no other alternatives shown).

Preferably, the at least one radial hole 24 of each pocket 22 includes a plurality of sets of radial holes 24. Each one of the sets of radial holes 24 is spaced circumferentially about the center C_{P} of a separate one of the plurality of pockets 22. As such, the radial surface 23 of each one of the pockets 22 is collectively defined by a plurality of radial surface sections 23a spaced circumferentially about the center C_{P} of the pocket 22. Further, the surface sections 23a are spaced apart by a separate one of a plurality of rectangular openings 26 located between each pair of adjacent radial surface sections 23a.

Most preferably, each set of radial holes 24 includes thirteen holes 24 and the radial surface 23 correspondingly includes thirteen surface sections 23a. However, as discussed above, the cage 10 may be formed such that only a single radial hole 24 is provided for each pocket 22, or with sets of holes 24 having any desired number of radial holes 24 (e.g., two, three, etc.), depending on the diameter of the pocket 22 and/or of each radial hole 24. For example, each set 28 of radial holes 24 may include ten circular holes 24 as shown in FIG. 5, four circular holes 24 as shown in FIG. 6, i.e., so as to resemble a “four leaf” structure, or any other number of desired holes 24 of any desired shape.

Referring particularly to FIG. 4, each radial hole 24 preferably has both a first opening 28A at the inner circumferential surface 21A of the cage annular body 20 and a second opening 28B at the outer circumferential surface 21B of the cage body 20. Thus, each radial hole 24 preferably extends entirely between the inner and outer circumferential surfaces 21A, 21B. As such, grease G (FIG. 8) or other lubricant stored within the storage space S_{S} provided by each radial hole 24 may either pass radially inwardly through the first opening 26A to lubricate the inner raceway 15 or pass radially outwardly through the second opening 26B to lubricate the outer raceway 17.

However, one or more radial holes 24, or even all of the holes 24, may be formed having an opening 26A or 26B at one of the inner and outer circumferential surfaces 21A, 21B and a blind end (not shown) disposed radially between the inner and outer circumferential surfaces 21A, 21B. Particularly when a hole 24 has an opening 28B at the outer circumferential 21B, each radial hole 24 with a blind end retains lubricant/grease for use within the connected pocket 22 rather than allowing the grease to be directed radially inwardly toward the inner raceway 15.

Preferably, the cage 10 is formed of a polymeric material in a molding process or by additive manufacturing. However, the cage 10 may be formed of any other appropriate material and/or manufacturing process, such as for example, being formed of a metallic material in a stamping process.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

I claim:

1. A cage for a bearing, the bearing including an inner body having an inner raceway surface, an outer body disposed about the inner body so as to define an annular space, the outer body having an outer raceway surface, and a plurality of rolling elements disposed within the annular space and rollable simultaneously upon the inner raceway surface and the outer raceway surface, the cage comprising:
an annular body disposeable within the annular space between the inner body and the outer body, having a centerline and including a plurality of pockets spaced circumferentially about the centerline, each pocket being defined by a separate radial surface and configured to retain a separate one of the plurality of rolling elements, and at least one radial hole intersecting the radial surface of one of the plurality of pockets and providing a storage space for lubricant.

2. The cage as recited in claim 1, wherein the at least one radial hole includes a plurality of radial holes, at least one radial hole intersecting each one of the plurality of pockets.

3. The cage as recited in claim 1, wherein the annular body has an inner circumferential surface and an outer circumferential surface, the radial surface of each one of the plurality of pockets and the at least one radial hole extending radially between the inner and outer circumferential surfaces of the annular body.

4. The cage as recited in claim 1, wherein the at least one radial hole is defined by a cylindrical surface extending radially between the inner and outer circumferential surfaces of the annular body and intersecting the radial surface of the one pocket so as to define a rectangular opening between the at least one pocket and the at least one radial hole.

5. The cage as recited in claim 4, wherein the cylindrical surface is rectangular or circular.

6. The cage as recited in claim 4, wherein each one of the plurality of pockets has a center and the at least one radial hole includes a plurality of sets of radial holes, each one of the sets of radial holes being spaced circumferentially about the center of a separate one of the plurality of pockets such that the radial surface of each one of the pockets is collectively defined by a plurality of radial surface sections spaced circumferentially about the center of the pocket, a separate one of a plurality of rectangular openings being located between each pair of adjacent cylindrical surface sections.

7. The cage as recited in claim 1, wherein the at least one radial hole has a first opening at the inner circumferential surface of the annular body and a second opening at the outer circumferential surface of the annular body.

8. The cage as recited in claim 1, wherein each one of the plurality of pockets has a center and the at least one radial hole includes a plurality of sets of radial holes, each one of the sets of radial holes being spaced circumferentially about the center of a separate one of the plurality of pockets and intersecting the radial surface of the one pocket, the radial surface of the one pocket including a plurality of radial surface sections spaced circumferentially about the center of the pocket.

9. The cage as recited in claim 8, wherein each radial hole of each set of radial holes is defined by a cylindrical surface intersecting the cylindrical surface of the one pocket connected to the set of holes such that a rectangular opening is defined between the pocket and each radial hole of the set of radial holes.

10. The cage as recited in claim 1, wherein the annular body is formed of a polymeric material in a molding process or an additive manufacturing process.

11. A bearing comprises:
an inner body having an inner raceway surface and a central axis;
an outer body disposed about the inner body so as to define an annular space, the outer body having an outer raceway surface;
a plurality of rolling elements disposed within the annular space and rollable simultaneously upon the inner raceway surface and the outer raceway surface; and
a cage including an annular body disposeable within the annular space between the inner body and the outer body, having a centerline and including a plurality of pockets spaced circumferentially about the centerline, each pocket being defined by a separate radial surface and configured to retain a separate one of the plurality of rolling elements, and at least one radial hole intersecting the radial surface of one of the plurality of pockets and providing a storage space for lubricant.

12. The bearing as recited in claim 11, wherein the at least one radial hole includes a plurality of radial holes, at least one radial hole intersecting each one of the plurality of pockets.

13. The bearing as recited in claim 11, wherein the annular body has an inner circumferential surface and an outer circumferential surface, the radial surface of each one of the plurality of pockets and the at least one radial hole extending radially between the inner and outer circumferential surfaces of the annular body.

14. The bearing as recited in claim 11, wherein the at least one radial hole is defined by a cylindrical surface extending radially between the inner and outer circumferential surfaces of the annular body and intersecting the radial surface of the one pocket so as to define a rectangular opening between the at least one pocket and the at least one radial hole.

15. The bearing as recited in claim 14, wherein the cylindrical surface is rectangular or circular.

16. The bearing as recited in claim 14, wherein each one of the plurality of pockets has a center and the at least one radial hole includes a plurality of sets of radial holes, each one of the sets of radial holes being spaced circumferentially about the center of a separate one of the plurality of pockets such that the radial surface of each one of the pockets is collectively defined by a plurality of radial surface sections spaced circumferentially about the center of the pocket, a separate one of a plurality of rectangular openings being located between each pair of adjacent cylindrical surface sections.

17. The bearing as recited in claim 11, wherein the at least one radial hole has a first opening at the inner circumferential surface of the annular body and a second opening at the outer circumferential surface of the annular body.

18. The bearing as recited in claim 11, wherein each one of the plurality of pockets has a center and the at least one radial hole includes a plurality of sets of radial holes, each one of the sets of radial holes being spaced circumferentially about the center of a separate one of the plurality of pockets and intersecting the radial surface of the one pocket, the radial surface of the one pocket including a plurality of radial surface sections spaced circumferentially about the center of the pocket.

19. The bearing as recited in claim 18, wherein each radial hole of each set of radial holes is defined by a cylindrical surface intersecting the cylindrical surface of the one pocket connected to the set of holes such that a rectangular opening is defined between the pocket and each radial hole of the set of radial holes.

20. The bearing as recited in claim 11, wherein the annular body is formed of a polymeric material in a molding process or an additive manufacturing process.
